(19) United States
(12) Patent Application Publication
(10) Pub. No.: US 2024/0177576 A1
(43) Pub. Date: May 30, 2024

(54) Imaging Systems and Methods for Monitoring Items in Predetermined Areas

(71) Applicant: ZEBRA TECHNOLOGIES CORPORATION, Lincolnshire, IL (US)

(72) Inventors: Darran Michael Handshaw, Sound Beach, NY (US); David Bellows, Old Westbury, NY (US); Edward Barkan, Miller Place, NY (US); Yuri Astvatsaturov, Lake Forest, IL (US)

(21) Appl. No.: 18/072,218

(22) Filed: Nov. 30, 2022

(51) Int. Cl. G07G 3/00; G06Q 20/18; G06V 20/52; G06V 40/16; G06V 40/20

(52) U.S. Cl. CPC G07G 3/003; G06Q 20/18; G06V 20/52; G06V 40/16; G06V 40/20; G06Q 20/208

(57) ABSTRACT

Imaging systems and methods monitor items associated with a person appearing in predetermined areas in a venue. A person is associated with an item when in a first area, using captured image data and attributes identified therein. The person is subsequently detected at a point-of-sale (POS) or other second area, through captured second image data and attributes identified therein. Responsive to detecting the person at the POS station, the method monitors a checkout transaction for scanning the previously-associated item, wherein failure of that item to be scanned prior to a payment step of a checkout transaction determines an instance of a potential shrink event.

### BACKGROUND

Products or items situated in consumer-oriented venues routinely face the risk of shrink events (e.g., theft). Operators of such venues generally employ conventional means to prevent such shrink events including, for example, use of onsite personnel to manually look for and detect suspicious activity among would-be consumers. However, such conventional means typically fail to capture all or most shrink events, especially at scale when many consumers are located in a given venue and/or when sophisticated criminals seek to move products or items between different areas of the venue, and, ultimately out of the venue's purview.

Accordingly, there is a need for imaging systems and methods for reducing shrink in high risk areas, as further described herein.

### SUMMARY

In an embodiment, the present invention is a method including: associating a person with an item acquired within a predefined zone of a venue by capturing first image-data via a first imaging assembly and analyzing the first image-data to identify at least one attribute of the person and at least one attribute of the item; detecting the person at a point-of-sale (POS) station of the venue by capturing second image-data via a second imaging assembly and analyzing the second image-data to identify the at least one attribute of the person; responsive to the detecting the person at the POS station, monitoring a checkout transaction for a scanning of the item, wherein the scanning of the item adds the item to a transaction log; and responsive to the item not being scanned prior to a payment step of the checkout transaction, determining an instance of a potential shrink event.

In another embodiment, the present invention is a system including: a first imaging assembly disposed within a venue, the first imaging assembly configured to capture images over at least a portion of a predefined zone located physically within the venue; a second imaging assembly associated with a point-of-sale (POS) station; a server communicatively connected to the first imaging assembly and the second imaging assembly; and computing instructions stored on a memory accessible by the server, and that when executed by one or more processors communicatively connected to the server, cause the one or more processors to: associate a person with an item acquired within a predefined zone of a venue by capturing first image-data via the first imaging assembly and analyzing the first image-data to identify at least one attribute of the person and at least one attribute of the item; detect the person at the point-of-sale (POS) station of the venue by capturing second image-data via the second imaging assembly and analyzing the second image-data to identify the at least one attribute of the person; responsive to the detecting the person at the POS station, monitor a checkout transaction for a scanning of the item, wherein the scanning of the item adds the item to a transaction log; and responsive to the item not being scanned prior to a payment step of the checkout transaction, determine an instance of a potential shrink event.

In still yet another embodiment, the present invention is a tangible, non-transitory computer-readable medium storing instructions, that when executed by one or more processors cause the one or more processors to: associate a person with an item acquired within a predefined zone of a venue by capturing first image-data via a first imaging assembly and analyzing the first image-data to identify at least one attribute of the person and at least one attribute of the item; detect the person at a point-of-sale (POS) station of the venue by capturing second image-data via a second imaging assembly and analyzing the second image-data to identify the at least one attribute of the person; responsive to the detecting the person at the POS station, monitor a checkout transaction for a scanning of the item, wherein the scanning of the item adds the item to a transaction log; and responsive to the item not being scanned prior to a payment step of the checkout transaction, determine an instance of a potential shrink event.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a venue having multiple POS stations, lanes, and imaging assemblies, in accordance with example embodiments herein.

FIG. 2 is a block diagram representative of an embodiment of a computing device of FIG. 1.

FIG. 3 is a block diagram illustrating an example implementation of an imaging assembly, as may be used in the venue of FIG. 1, in accordance with various embodiments.

FIG. 4 is a flowchart of an imaging method or otherwise algorithm for reducing shrink in predetermined areas in accordance with an example embodiment.

FIGS. 5-7 illustrate a venue having multiple POS stations and a person moving through the venue initially to a predetermined area of interest to collect an item and then to a POS station, in accordance with embodiments herein.

FIG. 8 illustrates a POS station and lane, in accordance with embodiments herein.

FIG. 9 is a flow chart of a further imaging method or otherwise algorithm for reducing shrink in predetermined areas in accordance with an example embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The embodiments of the present disclosure utilize camera devices and/or other image sensors, and other similar devices, embedded within or otherwise as part of imaging assemblies which are networked within a venue, e.g., a retail venue or store location, to create intelligent systems and methods to address the issue of reducing shrink in predetermined (e.g., high risk) areas of the venue. In various embodiments disclosed herein, one or more imaging assemblie(s) are disposed within a venue. Generally speaking, each of the plurality of sensors may provide a data stream at least partially representative of a movement of at least one object (e.g., such as a person or a shopping cart) and/or products or items. In some embodiments, each of the plurality of sensors may include a video camera, where the data stream includes a video stream capturing the movement of the at least one object (e.g., person or item) within the venue. More specifically, in various embodiments, the one or more imaging assemblie(s) may collect image data of specific predetermined areas of a store for the purpose of associating identified items in those predetermined areas with a person who has collected the items from those areas. That associated item and person, thereafter, may or may not be tracked throughout the store by other imaging assemblies, so long as at least one imaging assembly or other data collector is able to confirm the item and associated person at a store exit point, such as at a point-of-sale location.

In various aspects, imaging products and/or items within a venue together with scanning of products and/or items at a point-of-sale (POS) station can be used to detect and prevent items from being stolen. Such systems and methods can detect and prevent instances of shrink typically experienced in predetermined (e.g., high-risk) areas of the store as further described herein. In particular, in various aspects, imaging products are configured to associate a person with an item acquired within a predefined area of a venue, for example, through captured image data. Detecting the person at a POS station, an imaging assembly can analyze captured image data at the POS and monitor for scanning of the associated item at the POS. If the associated item is not scanned, a potential shrink event is determined.

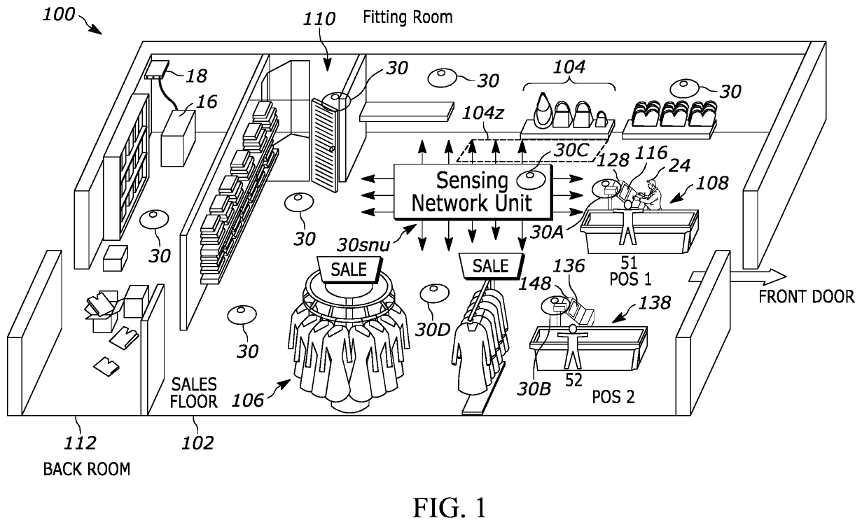

FIG. 1 illustrates a perspective view, as seen from above, of a venue 100 having multiple POS stations, lanes, and imaging assemblies 30, in accordance with example embodiments herein. In the example embodiment of FIG. 1, venue 100 includes a back room 112 that has a centralized controller 16. Venue 100 also includes a fitting room 110, and a retail sales floor 102 with various retail items (e.g., 104 and 106), and two POS stations (108 and 138) that each have respective POS lanes (POS lane 1 and POS lane 2). Each of the POS stations (108 and 138) may include various equipment. For example, POS station 108 may include a computer system 116 and an interface 128 that may include, for example, an optical scanner, touchpad, keypad, display, and data input/output interface connecting to the computer system 116. The computer system 116 may be operated by store personnel 24, which may be, for example, an employee, contract worker, owner, or other operator of the retail store. POS station 138 may similarly include a computer system 136 and an interface 148 that may include, for example, an optical scanner, touchpad, keypad, display, and data input/output interface connecting to the computer system 136. In some aspects, POS station 138 may not be operated by store personnel and, therefore, at least in some embodiments may represent a closed, inactive, or otherwise empty POS lane or station, or, additionally or alternatively, POS station 138 may constitute a self-checkout (SCO) station.

Each of the POS stations 108 and 138 have related POS lanes, which include POS lane 1 and POS lane 2, respectively. Individuals, such as customers, store personnel, or other individuals, may reside in, move through, or otherwise occupy the POS lanes at various times. Such individuals may be carrying, or be associated with (e.g., pushing a shopping cart, etc.) one or more related products (e.g., products 104 or 106) or other store merchandise. For example, one or more individual(s) 51 may occupy POS lane 1, where individual(s) 51 may represent customers at POS station 108 checking out, standing in line, and/or interacting with store personnel 24.

As another example, one or more individual(s) 52 may occupy or move through POS lane 2, where individual(s) 52 may represent customers moving through POS lane 2, for example, either entering or exiting the venue 100, or checking out with POS station 138, or otherwise interacting with POS station 138. For example, in some embodiments, POS station 138 may be an SCO station, where computer system 136 is configured to scan consumer products and accept payment from customers for products that the consumers bring to POS station 138 and POS lane 2.

The venue 100 further includes the centralized controller 16 that may comprise a networked host computer or server. The centralized controller 16 may be connected to one or more imaging assemblie(s) 30 positioned throughout the venue 100 via the network switch 18. As further described herein, the imaging assemblies 30 are able to capture image data and communicate that image data to a centralized controller 16 for detection of targets including, for example, people, such as store personnel 24 or consumers within the store (not shown), as well as the various retail products or items being offered for sale on the sales floor 102, e.g., clothes 106, handbags 104, etc., that are arranged on shelves, hangers, racks, etc. In particular, the imaging assemblie(s) 30 may be positioned throughout the venue 100 to capture image data that is analyzed to detect and identify one or more targets and to associate a person with those one or more targets. Different imaging assemblie(s) 30 may be positioned to capture such image data for different locations within the venue 100. For example, one or more attributes of a person may be identified in captured image data to identify a person and one or more attributes of an item may be identified in the same or otherwise associated captured image data to identify an item that is correspondingly associated with the identified person. For example, an item may be identified within the image data, e.g., by identifying a UPC code on the item and determining the item from the UPC code. The item may be identified during a checkout transaction, e.g., based on one or more identified attributes of a person and by decoding an indicia (e.g., a barcode) on the item captured in image data of imaging assemblie(s) associated with a checkout lane. As used herein, references to identifying a person (or the identity of a person) performed within the venue at predetermined areas such as high-risk areas, can refer to identifying the specific identity of the person or, instead of identifying the specific identity, identifying attributes of a person, where the system does not determine the identity of the person. The later scenario is particularly used in jurisdictions and situations where policy or other protections are in place to prevent collection and use of data used to specifically identify a person. The later scenario involves identifying attributes of a person sufficient to associate that person with the one or more targets in the venue 100 and sufficient to later identify those attributes for disassociating that person from the one or more targets. The specific identity of the person need not be determined. For example, in various embodiments, the imaging assemblies identify that a person is associated with the one or more targets, by identifying the presence of any person in captured image data and then by further identifying sufficient attributes of the particular person so that those attributes (not the person's specific identity) can be assessed at a later point.

The captured image data may be analyzed, for example, at the centralized controller 16 or at the computer systems 116 and 136 to identify the person (e.g., identifying attributes of the person) and to identify the item associated with the person from the image data captured by imaging assemblie(s) 30. Thus, in one aspect, centralized controller 16 may be communicatively coupled to a sensing network unit 30snu comprising one or more imaging assemblies as a group. In the example of FIG. 1, imaging assemblies 30A, 30B, 30C, and 30D are connected to sensing network unit 30snu, which is connected to the centralized controller 16. Sensing network unit 30snu may control imaging assemblies 30A, 30B, 30C, and/or 30D for specific tracking and/or monitoring of target objects within venue 100. The imaging assemblie(s) 30 may also be individually connected to a backend host.

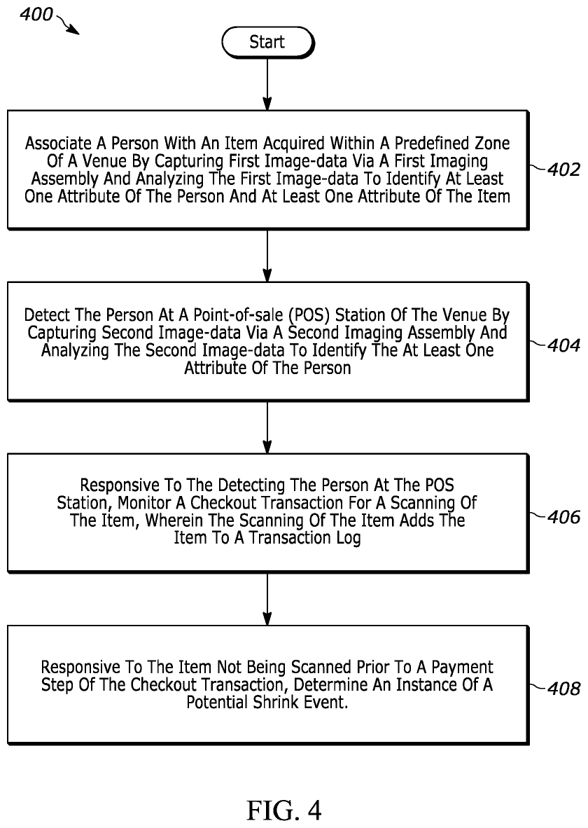

Additionally, in various examples, one or more of the POS stations 108 and 138 may have an imaging assembly that captures image data at the point of sale. For example, the POS stations 108 and 138 may be bi-optic stations, each with one or more imaging assemblies capturing image data over respective fields of view (FOV). Image data captured at the POS stations 108 and 138 or other data is further used to identify the person (e.g., attributes of the person) and attempt to identify the item previously associated with that person from analysis of the image data captured by the imaging assemblie(s). As illustrated in the examples of FIGS. 4-7 and processes and methods further described herein, the imaging assemblie(s) 30 capture image data detecting items in a venue, and the POS stations 108 and 138 capture data, such as image data, from a second location in a venue, where comparisons are used to detect for a shrink event.

Thus to affect various processes herein, each of the computer systems 116 and 136 may comprise one or more processors and may be in electronic communication with the centralized controller 16 via the network switch 18. The network switch 18 may be configured to operate via wired, wireless, direct, or networked communication with one or more of the imaging assemblies 30, where the imaging assemblies 30 may transmit and receive wired or wireless electronic communication to and from the network switch 18. The imaging assemblies may also be in wired and/or wireless communication with computer systems 116 and 136. Similarly, each of the imaging assemblies 30 may either be in wired or wireless electronic communication with the centralized controller 16 via the network switch 18. For example, in some embodiments, the imaging assemblies 30 may be connected via Category 5 or 6 cables and use the Ethernet standard for wired communications. In other embodiments, the imaging assemblies 30 may be connected wirelessly, using built-in wireless transceivers, and may use the IEEE 802.11 (WiFi) and/or Bluetooth standards for wireless communications. Other embodiments may include imaging assemblies 30 that use a combination of wired and wireless communication.

The interfaces 128 and 148 may provide a human/machine interface, e.g., a graphical user interface (GUI) or screen, which presents information in pictorial and/or textual form (e.g., representations of the products 104, 106). Such information may be presented to the store personnel 24, or to other store personnel such as security personnel (not shown). The computer systems (116, 136) and the interfaces (128, 148) may be separate hardware devices and include, for example, a computer, a monitor, a keyboard, a mouse, a printer, and various other hardware peripherals, or may be integrated into a single hardware device, such as a mobile smartphone, or a portable tablet, or a laptop computer. Furthermore, the interfaces (128, 148) may be in a smartphone, or tablet, etc., while the computer systems (116, 136) may be a local computer, or remotely hosted in a cloud computer. The computer systems (116, 136) may include a wireless RF transceiver that communicates with each imaging assembly 30, for example, via Wi-Fi or Bluetooth.

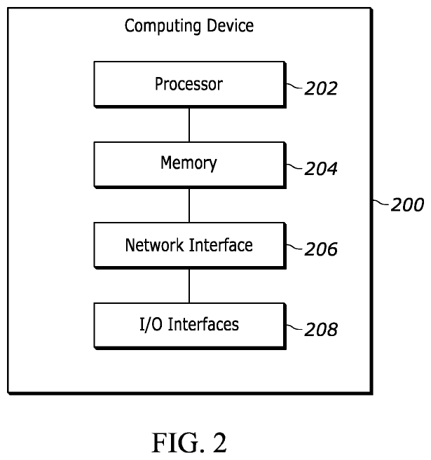

FIG. 2 is a block diagram representative of an embodiment of a computing device 200 that may be implemented as the centralized controller 16 or the computer systems 116, 136 of FIG. 1, by example. The computing device 200 is configured to execute computer instructions to perform operations associated with the systems and methods as described herein, for example, to implement the example operations represented by the block diagrams or flowcharts of the drawings accompanying this description. The computing device 200 may implement enterprise service software that may include, for example, RESTful (representational state transfer) API services, message queuing service, and event services that may be provided by various platforms or specifications, such as the J2EE specification implemented by any one of the Oracle WebLogic Server platform, the JBoss platform, or the IBM WebSphere platform, etc. As described below, the computing device 200 may be specifically configured for performing operations represented by the block diagrams or flowcharts of the drawings described herein. In some aspects, the computing device 200 may be located offsite the venue 100, and be implemented as a cloud-based server.

The example computing device 200 includes a processor 202, such as, for example, one or more microprocessors, controllers, and/or any suitable type of processor. The example computing device 200 further includes memory (e.g., volatile memory or non-volatile memory) 204 accessible by the processor 202, for example, via a memory controller (not shown). The example processor 202 interacts with the memory 204 to obtain, for example, machine-readable instructions stored in the memory 204 corresponding to, for example, the operations represented by the flowcharts of this disclosure. Additionally or alternatively, machine-readable instructions corresponding to the example operations of the block diagrams or flowcharts may be stored on one or more removable media (e.g., a compact disc, a digital versatile disc, removable flash memory, etc.), or over a remote connection, such as the Internet or a cloud-based connection, that may be coupled to the computing device 200 to provide access to the machine-readable instructions stored thereon.

The example computing device 200 may further include a network interface 206 to enable communication with other machines via, for example, one or more computer networks, such as a local area network (LAN) or a wide area network (WAN), e.g., the Internet. The example network interface 206 may include any suitable type of communication interface(s) (e.g., wired and/or wireless interfaces) configured to operate in accordance with any suitable protocol(s), e.g., Ethernet for wired communications and/or IEEE 802.11 for wireless communications. Interface 206 allows central controller 16 to communicate with other components of the venue 100 including, for example, imaging assemblie(s) 30 and POS station 108 and/or POS station 138.

The example computing device 200 includes input/output (I/O) interfaces 208 to enable receipt of user input and communication of output data to the user, which may include, for example, any number of keyboards, mice, USB drives, optical drives, screens, touchscreens, etc.

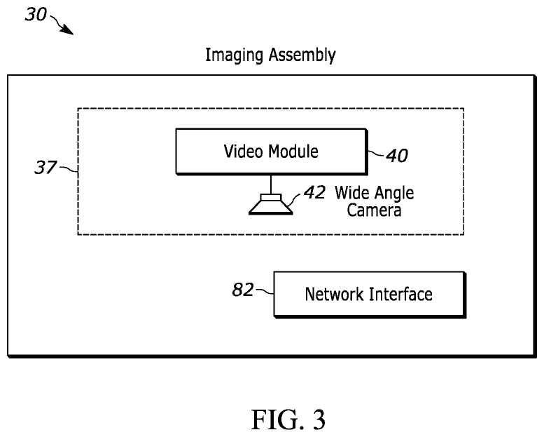

FIG. 3 is a block diagram illustrating an example implementation of an embodiment of an imaging assembly 30. In the illustrated example of FIG. 3, the imaging assembly 30 may further include a video detector 37 operative for detecting or locating a target by capturing an image of the target in the venue 100, such as a person moving through venue 100 or an item sitting on a shelf of venue 100. More particularly, the video detector 37 may be mounted in each imaging assembly 30 and may include a video module 40 having a camera controller that is connected to a camera 42, which may be, for example, a wide-angle field of view camera for capturing the image of a target. In some embodiments, camera 42 may be a high-bandwidth, video camera, such as a moving picture expert group (MPEG) compression camera. In other embodiments, the camera may include wide-angle capabilities such that camera 42 can capture images over a large area to produce a video stream of the images. As referred to herein, the image capture devices or video cameras (also referred to as image sensors herein) are configured to capture image data representative of the venue or an environment of the venue. Further, the image sensors described herein are example data capture devices, and example methods and apparatuses disclosed herein are applicable to any suitable type of data capture device(s). In various embodiments, the images or data from the images may be synchronized or fused with other data, such as RFID data, and used to further describe, via data, the venue or environment of the venue. Such synchronized or fused data may be used, for example, by the centralized controller 16 to make determinations or for other features as described herein.

As described, each of the imaging assemblies 30 may collect image data and locationing and direction of travel information from its one or more detectors, such as video detector 37 having wide angle camera 42. That information may be used to determine the location and/or direction of travel of the target, such as an item or person (e.g., by identifying attributes of a person). In particular, an imaging assembly 30 may filter captured video to segment out from the captured wide-angle video, images of the target near the target sensing station, as the target is moved through the venue. That segmenting may result in discarding video images that do not include the target or discarding portions of the wide-angle video that extend beyond an area of interest surrounding and including the target itself.

In various embodiments, focusing, image tilting, and image panning procedures may be determined by first performing image processing on the target in the wide-angle video stream. For example, in some embodiments, an imaging assembly 30 may perform target identification procedures over the determined field of view, procedures such as edge detection to identify the target, segmentation to segment out the target's image from other objects in the video stream, and a determination of any translational, rotational, shearing, or other image artifacts affecting the target image and that would then be corrected for before using the captured target image.

Any of the imaging assemblies 30, including alone, together, or some combination thereof, may transmit electronic information, including any image or video, or other information, to the computing device 200 for processing and/or analysis. For example, the computing device 200 of FIG. 2 may include a network communication interface 206 communicatively coupled to network communication interfaces 82 of the imaging assemblies 30 to receive sensing detector data, such as images and/or video stream data, such as a video stream from a camera 42, such as a wide-angle camera. The imaging assemblies 30 may also receive information, commands, or execution instructions, including requests to provide additional sensory or detection information from the computing device 200 to perform the features and functionally as described herein.

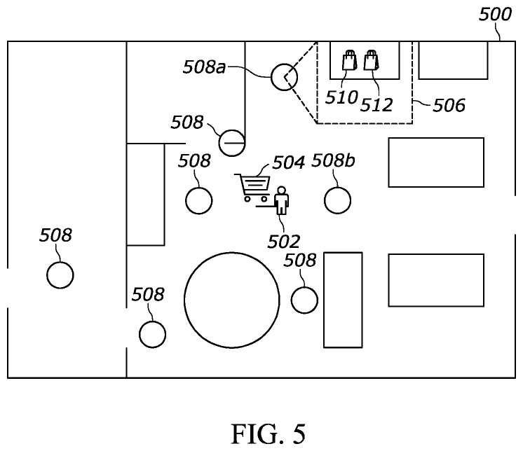

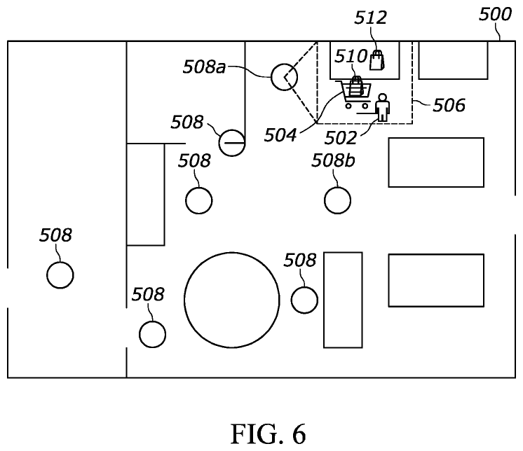

FIG. 4 is a flowchart of an imaging method 400 or otherwise algorithm for reducing shrink in predetermined (e.g., high risk) areas in accordance with an example embodiment. At block 402, imaging method 400 comprises associating a person (e.g., associating attributes of the person) with an item acquired within a predetermined zone of a venue by capturing first image-data via a first imaging assembly as described herein. In various aspects, the first imaging assembly may be a camera located on or in a proximity of a ceiling near a predefined zone (e.g., high risk zone defining a zone of typical theft or shrink events). For example, FIGS. 5 and 6 illustrate a venue in the form of a sales floor 500 in which a person 502 moves with a shopping cart 504, from one area to a predetermined zone 506 that is within a FOV of an imaging assembly 508a (other imaging assemblies 508 are positioned to image other areas of the venue). In some examples, the imaging assemblies may be positioned at shelf level or in another position lower than the ceiling, where imaging assemblies may be more likely to capture facial data of individuals and/or other attributes of items within the image data. The predefined zone 506 may be a zone identified by a supervisor, central controller, etc. as a zone to monitor for shrink events. Two items, in the form of handbags 510, 512, are in the predefined zone 506. In FIG. 5, the person 502 is not within the predefined zone 506 and therefore not identifiable in captured image data of the imaging assembly 508a. In FIG. 6, however, the person 502 has entered the predefined zone 506 and collected the item 510 by placing it in their shopping cart 504. In the examples of FIGS. 5 and 6, the imaging assembly 508a captures image data of the zone 506 and communicates that image data to a central controller (not shown) for person and item association. Thus, at block 402, imaging method 400 may analyze first captured image-data to identify at least one attribute of the person (e.g., person 502) and at least one attribute of the item (e.g., the item 510). In some examples that identification may be performed at the imaging assembly (e.g., imaging assembly 508), however in other examples, captured image data is communicated to the central controller which performs person (e.g., attributes of the person) and item identification. In some aspects, the at least one attribute of the person may include facial data (e.g., pixel data defining one or more of an eye, a nose, or mouth of the person) such that associating the person (e.g., individual 51) with the item (e.g., the handbag) acquired within the predetermined area of the venue further includes associating the facial data with the at least one attribute of the item (e.g., a hand strap and/or price tag of the handbag).

In still further aspects, associating the person (e.g., associating attributes of the person) with the item acquired within the predefined area (e.g., a zone) of the venue further includes: detecting an entry of the person into the predefined area, and identifying, via the first image-data, entry-items associated with the person. The entry-items may comprise one or more items brought into the predetermined area by the person. The method may further include detecting an exit of the person from the predetermined area. The first image-data may then be used to identify one or more exit-items associated with the person. The exit-items may comprise items brought out of the predetermined area by the person. Still further, the method may further comprise identifying the item acquired within the predetermined area of the venue based on a comparison between the entry-items and the exit-items. The method 400 allows for associating items acquired by the person in the predetermined area.

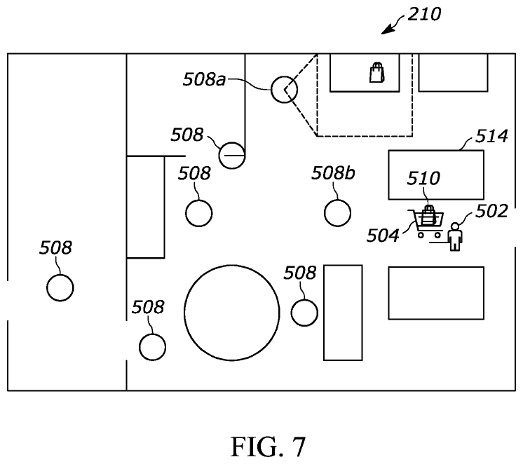

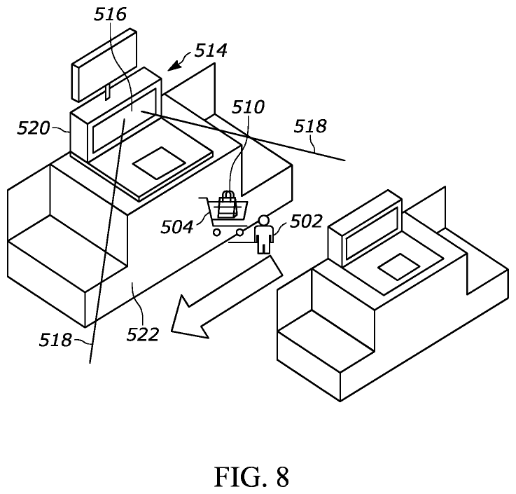

At block 404, imaging method 400 comprises detecting the person at a point-of-sale (POS) station of the venue by capturing second image-data via a second imaging assembly. FIG. 7 illustrates an example, where the person 502 has moved to a POS station 514 with the item 510 in their shopping cart 504. In some aspects, at block 404, a second imaging assembly 508b is associated with the POS station 514 and captures image data of the POS station and surrounding region from which the person and item are identified. That is, the second imaging assembly may comprise a camera above the POS area that captures image-data of the person and/or item(s). In some other aspects, that second imaging assembly may comprise a polychromatic image sensor associated with a barcode reader of the POS station (e.g., POS station 514). For example, in some aspects, the polychromatic image sensor may be positioned within the barcode reader and may have a field of view that extends at least partially over (i) a product scanning region of the POS station and (ii) a POS-user region of the POS station. FIG. 8, for example, illustrates that the POS 514 may be a bi-optic POS having an imaging assembly 516 with a FOV 518 directed at a checkout lane and that captures image data that may be sent to a central controller. While the POS associated imaging assembly is shown in a tower portion 520 of the bi-optic POS 514, in other examples, the imaging assembly may be mounted in a lower support portion 522 of the POS 514, for example to capture images separately from the images captured during SCO scanning by the person 502. Imaging method 400, at block 404, further comprises analyzing the second image-data to identify the at least one attribute of the person, which may be performed at the central controller or, in some examples, at the POS. The attribute of the person may be the same as that identified via the first imaging assembly (e.g., a facial attribute of the person).

At block 406, imaging method 400 comprises, responsive to the detecting the person at the POS station, monitoring a checkout transaction for a scanning of the item (e.g., handbag), wherein the scanning of the item adds the item to a transaction log. The transaction log may comprise a database or other data storage, such as memory 204, used to store and/or otherwise log items presented for purchase or items purchased.

In some aspects, responsive to the item being scanned prior to the payment step of the checkout transaction, the person may be disassociated with the item (e.g., handbag) for tracking purposes. That is, the person may still carry the item, but tracking of the person and/or the item may stop or tracking the two together may stop. For example, an imaging assembly 516 may detect that the person is in a line associated with a POS station, and because the item is scanned prior to the payment step of the checkout transaction, method 400 may determine (e.g., by a central controller) that the person no longer needs to be tracked or monitored in the venue or a portion thereof (e.g., sales floor 500). In some such aspects, a person may be disassociated with an item where a central controller removes an in-memory flag previously stored in memory for tracking the person in the venue.

In a still further aspect, responsive to detecting the person disposing of the item (e.g., handbag) prior to the payment step of the checkout transaction, the person may be disassociated with the item. For example, an imaging assembly 508 may capture images used to detect, by central controller 16, that the person has placed the item (e.g., handbag) within the venue, and method 400 may determine (e.g., by central controller 16) that the person no longer needs to be tracked or monitored in the venue.

At block 408, imaging method 400 comprises, responsive to the item (e.g., the handbag) not being scanned prior to a payment step of the checkout transaction, determining an instance of a potential shrink event. A shrink event can comprise, by way of non-limiting example, determination of a potential theft of the item. For example, the person may be identified based on a personal attribute (e.g., facial features of the person) at or near a POS station (e.g., POS station 514), but where the item, as previously identified (e.g., via first imaging assembly 508) is no longer identified (e.g., via the second imaging assembly 516), for example based on its features, at or near a POS station. Such activity may indicate that the person is engaged in illicit activity, e.g., theft of the item.

In some aspects, imaging method 400 may further comprise, responsive to the item not being scanned prior to the payment step of the checkout transaction, preventing the payment step of the checkout transaction from being completed. For example, when a potential shrink event is detected, the POS station 514 may automatically prevent payment for a checkout transaction from finishing, where personnel, including employees of the venue, may be alerted to investigate the person, and/or related item. For example, the central controller or the POS station may communicate an alert signal and person and/or item identification data to a supervisor's computing device that displays an alert. In some examples, the POS station may display a window advising the customer that an employee is on the way for assistance, a window asking the customer to confirm if all items have been scanned, etc.

In still further aspects, imaging method 400 may further comprise, responsive to the item (e.g., the handbag) not being scanned prior to the payment step of the checkout transaction, presenting a message associated with the item on a user-interface of the POS (e.g., POS station 108). The message may indicate to personnel (e.g., store personnel 24), including employees of the venue, to call security, check for the item, or take other action(s) associated with preventing a shrink event.

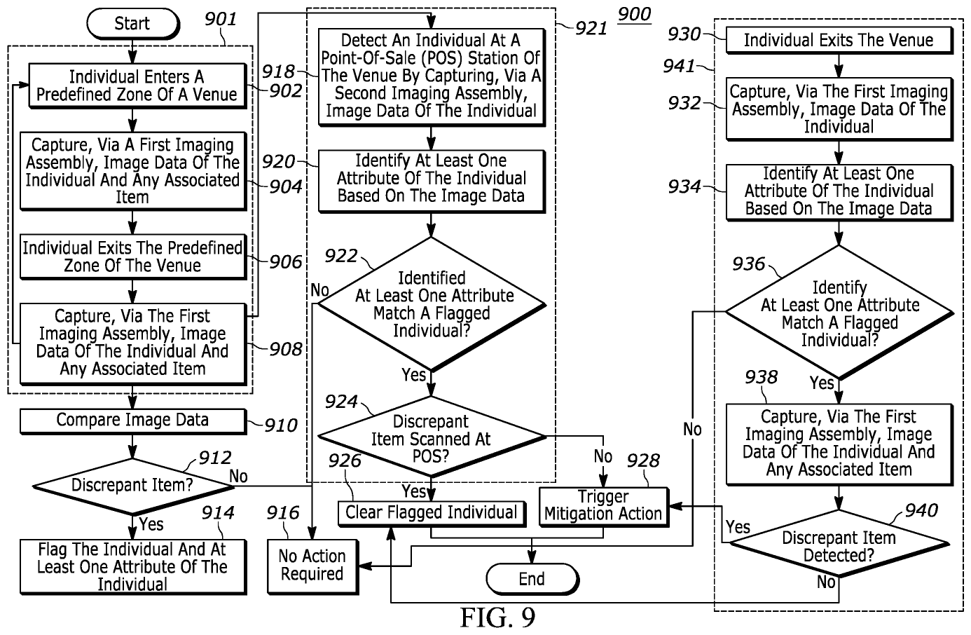

FIG. 9 is a flow chart of a further imaging method 900 or otherwise algorithm for reducing shrink in predetermined (e.g., high risk) areas in accordance with an example embodiment and as may be implemented by the environments (computer systems, central controllers, imaging devices, POS stations, etc. described and illustrated herein). Imaging method 900 is associated, by way of non-limiting example, with at least three areas of a venue (e.g., venue 100 or 500). These include a high shrink zone 901 (e.g., a zone near handbags 104 such as 104z or items 510, 512 such as 506), a point-of-sale (POS) zone 921 (e.g., POS station 108 or 514), and a store exit area 941 (e.g., an entrance/exit area of sales floor 102 of 500). It is to be understood, however, that additional, fewer, and/or different zones or areas may be used within a venue and with respect to the disclosure herein.

Generally, imaging method 900 captures image data via cameras (e.g., camera 42 of imaging assemblies 30) in areas identified as high shrink zones to determine whether customers leave the zones carrying the same or different items they walked in with. More generally, the high shrink zones could include, but are not limited to: bathroom entryways, fitting room entryways, quiet corners of the store, high ticket item areas, adjacent to exits, or near backroom entrances. The cameras (e.g., imaging assemblies 30) can optimally have a field-of-view (FOV) that can capture a person's face for facial recognition or facial anthropometry, the person's cart, and/or anything, such as item(s), they are carrying. Each of the blocks of method 900 may be determined based on image data captured by imaging assemblies, POS stations, etc. and processed by a central controller.

Corresponding to the high shrink zone 901, at a block 502 a person enters a predefined zone, which is detected by an imaging assembly, for example, by performing pattern matching, feature identification, or other image-based detection techniques to note the presence of an individual. In some examples, imaging assemblies are periodically or continuously capturing images of high shrink areas or zones throughout portions of the venue and sending those images to a central controller that identifies the individual entering the venue. In any event, where the person's presence is detected at the block 904 or they merely enter the predefined zone, at block 902, imaging method 900 captures, via a first imaging assembly, image data and that image data is analyzed to detect and identify a person and an item associated with that person. In some aspects, when the high shrink zone is a changing room area, an imaging assembly might just image, and record in memory, someone coming in and going out of the changing room area to check discrepant items found missing. More generally, if a person goes into an area not covered by vision (e.g., not covered by an imaging assembly 30) and leaves, mitigation events can be triggered. For instance, if a person walks into a changing room with an item and then walks out without it, a task or mitigation event might be triggered to have an employee check that area to recover the item.

At a block 906, the individual exists the predefined zone of the venue, and at a block 908, a subsequent image data is captured of the individual. For example, the imaging assembly capturing image data at the block 904 may continually capture image data until it is detected that person has left the predefined zone. The subsequently captured image data is analyzed to not only detect and identify the person but to attempt to detect and identify the item associated with the person at block 904. The captured image data from a block 908 is compared against the captured image data of block 904, at a block 910, to determine at a block 912 if there is a discrepancy. The comparison at block 910 may be of identification data and/or identified features of the person and item, for example. Further the comparison of block 910 allows for the block 912 to identify discrepancy when either the item or the person identified in the captured image data of block 908 does not match the item and person identified in the captured image data of block 904.

At block 912, if a discrepancy is detected, then at block 914 the person is flagged in memory and at least one attribute of the identified person is also obtained and stored in memory, for example, such memory may be at a central controller. Otherwise, if no such discrepancy is detected, then no further action is required in response to the process of 912 and that portion of the method 900 terminates at a block 916. As a further feature, in the illustrated example, control may be passed from the block 908 back to the block 902, if the individual re-enters the shrink zone 901 after exiting.

In the illustrated example, blocks 910 and 912 provide for shrink detection in the first predefined zone 901. The imaging method 900 further provides shrink detection in the second predefined zone 921. In the illustrated example, at a block 918, an individual is detected at a POS station by capturing image data from a second imaging assembly, different from that of blocks 904 and 908.

At block 920, the imaging method 900 identifies at least one attribute of the individual detected at block 918. For example, captured image data from the block 918 may be communicated to a central controller that stores captured image data from blocks 904 and 908 and corresponding identified attributes. At a block 922, the central controller compares identified attributes from block 920 to determine if there is a match to identified attributes from the image data from block 908, for example. If no attributes match (e.g., if the individual does not match an individual identified in the stored memory), then block 916 is accessed and the method 900 ends, indicating the individual at the POS does not match an individual who had been previously associated with an item in a predefined shrink zone. If there is a match at block 922, the control is passed to a block 924 to determine if there is a discrepancy with a scanned item at the POS.

At the block 924, the imaging method 900 obtains identification data of an item scanned at the POS. That identification data may be obtained from image data captured by an imaging assembly during scanning of the item by an individual (e.g., the imaging assembly 516 of a bi-optic 514) or by image data captured from another imaging assembly associated with a POS, such as an overhead imaging assembly (e.g., imaging assembly 508b). In an example, the block 924 identifies the item scanned and compares that item to the item associated with the individual from captured data of block 908. If the identified images match, the individual is cleared by the imaging method 900 at a block 926 and the process ends. If a discrepancy exists, then a mitigation action is triggered at a block 928. That is, if the attribute data of the item does not match a previously identified item associated with the person, then imaging method 900 performs a mitigation, for example by having a central controller trigger an alert.

Similar detection and mitigation can occur at the store exit area 941. For example, at a block 930 an individual may exit the venue, and at a block 932 an imaging assembly may capture image data of the individual and send that image data to a central controller, where at a block 934, one or more attributes of the individual are determined and the individual is identified. At a block 936, the imaging method 900 compares the one or more attributes from the block 934 to stored attributes in memory (e.g., at a central controller) to determine if there is a match. If a match is not determined, then the imaging method 900 passes control to a block 916 where no further action is taken and the process 900 ends. If the block 936 determines there is a match, then control passes to a block 938 where further image data is captured by an imaging assembly. That further image data is analyzed (e.g., at a central controller) to identify the individual and any item in the image data. At a block 940, the imaging method 900 determines if the item identified in the captured image data from 938 matches an item associated with the individual from the captured image data of block 908 (e.g., when the individual was leaving the shrink region). If the identified items match, the individual is cleared by the imaging method 900 at the block 926 and the process ends. If a discrepancy exists, then a mitigation action is triggered at a block 928.

Thus, with respect to imaging method 900, or elsewhere herein, in the case where an item is carried into a high shrink zone and is not carried out, a camera or other imaging assembly in the POS can use facial recognition and/or anthropometry to match a person flagged in one of the high shrink zones to the person checking out. If a match is detected, the system can then check to see whether the customer paid for the item that was flagged as missing in the high shrink zone. If the person did not pay for that item during checkout scanning, a mitigating event can then be activated. The mitigating event could be to print a different color or symbol on the receipt so an employee at the door knows to check it, a task can be created for an employee to check the person's cart and receipt on a mobile device, the checkout process can be frozen before completion until an employee can come verify things, and/or a record of the video footage from both checkout and the high shrink zone can be retained for future review.

The above described systems and methods thus allow for tracking an item and/or person without robust infrastructure (e.g., numerous cameras and tracking software) by utilizing imaging assemblies focused on predetermined areas, and where the image data received from these predetermined areas is checked at a point of sale, without needing to track either the item or the person continually throughout a venue.

In the foregoing specification, the above description refers to one or more block diagrams of the accompanying drawings, e.g., FIGS. 2-4 and 9. Alternative implementations of the examples represented by the block diagrams includes one or more additional or alternative elements, processes and/or devices. Additionally or alternatively, one or more of the example blocks of the diagrams may be combined, divided, re-arranged or omitted. Components represented by the blocks of the diagrams are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A method comprising:
associating a person with an item acquired within a predefined zone of a venue by capturing first image-data via a first imaging assembly and analyzing the first image-data to identify at least one attribute of the person and at least one attribute of the item;
detecting the person at a point-of-sale (POS) station of the venue by capturing second image-data via a second imaging assembly and analyzing the second image-data to identify the at least one attribute of the person;
responsive to the detecting the person at the POS station, monitoring a checkout transaction for a scanning of the item, wherein the scanning of the item adds the item to a transaction log; and
responsive to the item not being scanned prior to a payment step of the checkout transaction, determining an instance of a potential shrink event.

2. The method of claim 1, further comprising responsive to the item being scanned prior to the payment step of the checkout transaction, disassociating the person with the item.

3. The method of claim 1, further comprising, responsive to the item not being scanned prior to the payment step of the checkout transaction, preventing the payment step of the checkout transaction from being completed.

4. The method of claim 1, further comprising, responsive to the item not being scanned prior to the payment step of the checkout transaction, presenting a message associated with the item on a user-interface of the POS.

5. The method of claim 1, wherein the second imaging assembly is comprised of a polychromatic image sensor associated with a barcode reader of the POS station.

6. The method of claim 5, wherein the polychromatic image sensor is positioned within the barcode reader and has a field of view that extends at least partially over (i) a product scanning region of the POS station and (ii) a POS-user region of the POS station.

7. The method of claim 1, wherein at least one attribute of the person includes facial data, and wherein the associating the person with the item acquired within the predefined zone of the venue further includes associating the facial data with the at least one attribute of the item.

8. The method of claim 1, wherein the associating the person with the item acquired within the predefined zone of the venue further includes:
detecting an entry of the person into the predefined zone;
identifying, via the first image-data, entry-items associated with the person, the entry-items being items brought into the predefined zone by the person;
detecting an exit of the person from the predefined zone;
identifying, via the first image-data, exit-items associated with the person, the exit-items being items brought out of the predefined zone by the person; and
identifying the item acquired within the predefined zone of the venue based on a comparison between the entry-items and the exit-items.

9. The method of claim 1, further comprising:
responsive to detecting the person disposing of the item prior to the payment step of the checkout transaction, disassociating the person with the item.

10. A system comprising:
a first imaging assembly disposed within a venue, the first imaging assembly configured to capture images over at least a portion of a predefined zone located physically within the venue;
a second imaging assembly associated with a point-of-sale (POS) station;
a server communicatively connected to the first imaging assembly and the second imaging assembly; and
computing instructions stored on a memory accessible by the server, and that when executed by one or more processors communicatively connected to the server, cause the one or more processors to:
associate a person with an item acquired within a predefined zone of a venue by capturing first image-data via the first imaging assembly and analyzing the first image-data to identify at least one attribute of the person and at least one attribute of the item;
detect the person at the point-of-sale (POS) station of the venue by capturing second image-data via the second imaging assembly and analyzing the second image-data to identify the at least one attribute of the person;
responsive to the detecting the person at the POS station, monitor a checkout transaction for a scanning of the item, wherein the scanning of the item adds the item to a transaction log; and
responsive to the item not being scanned prior to a payment step of the checkout transaction, determine an instance of a potential shrink event.

11. The system of claim 10, further comprising responsive to the item being scanned prior to the payment step of the checkout transaction, disassociating the person with the item.

12. The system of claim 10, further comprising, responsive to the item not being scanned prior to the payment step of the checkout transaction, preventing the payment step of the checkout transaction from being completed.

13. The system of claim 10, further comprising, responsive to the item not being scanned prior to the payment step of the checkout transaction, presenting a message associated with the item on a user-interface of the POS.

14. The system of claim 10, wherein the second imaging assembly is comprised of a polychromatic image sensor associated with a barcode reader of the POS station.

15. The system of claim 14, wherein the polychromatic image sensor is positioned within the barcode reader and has a field of view that extends at least partially over (i) a product scanning region of the POS station and (ii) a POS-user region of the POS station.

16. The system of claim 10, wherein at least one attribute of the person includes facial data, and wherein the associating the person with the item acquired within the predefined zone of the venue further includes associating the facial data with the at least one attribute of the item.

17. The system of claim 10, wherein the associating the person with the item acquired within the predefined zone of the venue further includes:
detecting an entry of the person into the predefined zone;
identifying, via the first image-data, entry-items associated with the person, the entry-items being items brought into the predefined zone by the person;
detecting an exit of the person from the predefined zone;
identifying, via the first image-data, exit-items associated with the person, the exit-items being items brought out of the predefined zone by the person; and
identifying the item acquired within the predefined zone of the venue based on a comparison between the entry-items and the exit-items.

18. The system of claim 10, further comprising:
responsive to detecting the person disposing of the item prior to the payment step of the checkout transaction, disassociating the person with the item.

19. A tangible, non-transitory computer-readable medium storing instructions, that when executed by one or more processors cause the one or more processors to:
associate a person with an item acquired within a predefined zone of a venue by capturing first image-data via a first imaging assembly and analyzing the first image-data to identify at least one attribute of the person and at least one attribute of the item;
detect the person at a point-of-sale (POS) station of the venue by capturing second image-data via a second imaging assembly and analyzing the second image-data to identify the at least one attribute of the person;
responsive to the detecting the person at the POS station, monitor a checkout transaction for a scanning of the item, wherein the scanning of the item adds the item to a transaction log; and
responsive to the item not being scanned prior to a payment step of the checkout transaction, determine an instance of a potential shrink event.

20. The tangible, non-transitory computer-readable medium of claim 19, wherein the computing instructions, when executed by the one or more processors, are further configured to:
responsive to the item being scanned prior to the payment step of the checkout transaction, disassociate the person from the item.
